(19) United States
(12) Patent Application Publication
(10) Pub. No.: US 2018/0204179 A1
(43) Pub. Date: Jul. 19, 2018

(54) CARPOOL-BASED PACKAGE DELIVERY METHOD, SYSTEM, AND SERVER

(71) Applicant: GUANGZHOU WOXI INFORMATION TECHNOLOGY CO., LTD., Guangzhou (CN)

(72) Inventor: Zhaoxing ZENG, Guangzhou (CN)

(73) Assignee: GUANGZHOU WOXI INFORMATION TECHNOLOGY CO., LTD., Guangzhou (CN)

(21) Appl. No.: 15/919,354

(22) Filed: Mar. 13, 2018

Related U.S. Application Data
(63) Continuation-in-part of application No. PCT/CN2016/100234, filed on Sep. 27, 2016.

(30) Foreign Application Priority Data
Apr. 13, 2016 (CN) 201610227888.1

(51) Int. Cl. G06Q 10/08; G06Q 50/30; G01C 21/34

(52) U.S. Cl. CPC G06Q 10/08355; G01C 21/3438; G06Q 50/30

(57) ABSTRACT

A carpool-based package delivery method, including the steps of: acquiring first origin information and first destination information of a package, generating a first delivery path, and delivering the package; acquiring second origin information and second destination information of a number of passengers; and when the second origin information is within a first preset distance from the first delivery path and the second destination information is within a second preset distance from the first delivery path, listing the passengers as possible pickup passengers and issuing prompts. By using the origin information, the destination information, and arrival time information of the package, possible carpool passengers nearby may be screened out from the beginning, not only ensuring that the package can arrive at the destination on time and the price is reduced, but also ensuring that the riding customer can ride at a discount through such carpool.

This non-provisional patent application is a Continuation In Part application of International Application PCT/CN2016/100234, filed on Sep. 27, 2016, which is based upon and claims priority to Chinese Application No. 201610227888.1 filed on Apr. 13, 2016, the entire contents of which are incorporated herein by reference.

### TECHNICAL FIELD

The present invention relates to the field of urban transportation and, in particular, to a carpool-based package delivery method, system, and server.

### BACKGROUND

Taxis are an important part of traffic of cities. At present, the total number of taxis in China has reached more than 1.1 million and the annual passenger volume reaches 12 billion trips, producing imaginable energy consumption. Moreover, at present, most taxis can carry passengers from only one place, and in most cases, only one passenger, resulting in a great waste of resources. On the other hand, with the rapid development of online shopping, the express service industry has also seen explosive growth in recent years. No matter for individuals or companies, more goods are delivered by express.

In existing package delivery methods, it usually takes 6 hours or even 24 hours to complete the delivery of packages within a same city or from adjacent cities due to the package quantity and the logistics arrangement. In more urgent cases, a sender can only take goods directly to a designated destination by taxi. At the time of delivery, a courier needs to notify a user of the arrival of a package before delivery. In this process, there are disadvantages such as that the user is not at home and cannot take the package or is in a hurry and cannot wait for the courier to arrive. Separately sending a taxi to deliver a package costs relatively much higher.

In addition, in existing logistics delivery processes, a package needs to be delivered by a courier and a recipient in person, but the recipient may not be at a delivery address when the courier delivers the package and cannot sign the package in person. Moreover, restricted by factors such as working hours and areas in charge of couriers, the delivery efficiency and the delivery success rate are low, and imperfect links and procedures not only have greatly aggravated the workload of the logistics industry, but also cause great inconvenience to recipients.

### SUMMARY OF THE INVENTION

Based on the above situation, the present invention proposes a carpool-based package delivery method. In a same city, since a package belongs to a taxi that can receive the package within a certain period of time, an emergency package can be delivered within the same city by sending the taxi to carry the package from an origin to a destination. However, this situation is relatively rare and the cost may be relatively much higher. If passengers are picked up on the same path within the scheduled time for the package, the corresponding costs can be shared.

The present invention discloses a carpool-based package delivery method, including the steps of: acquiring first origin information and first destination information of a package, generating a first delivery path, and delivering the package; acquiring second origin information and second destination information of a number of passengers; and when the second origin information is within a first preset distance from the first delivery path and the second destination information is within a second preset distance from the first delivery path, listing the passengers as possible pickup passengers and issuing prompts.

Package arrival time information is acquired; a time taken by a taxi to travel from a second origin where the passenger is picked up to a first destination is calculated, so as to acquire taxi arrival time information; and if the taxi arrival time information is later than the delivery arrival time information, the passenger is excluded from the possible pickup passengers.

Delivery path direction information is acquired according to the first origin information and the first destination information; riding path direction information is acquired according to the second origin information and the second destination information of the passenger; and the delivery path direction information is the same as the riding path direction information.

Address information of a first user in a community is acquired after the package is delivered to the first destination; address information of a number of second users corresponding to all current packages is acquired; and packages for which address information of the second user is within a preset distance range from the first user are screened out and delivered by the first user.

The present invention further discloses a carpool-based package delivery system, including a package delivery client, a server, and a passenger client, wherein the package delivery client is configured to acquire first origin information and first destination information of a package; the passenger client is configured to acquire second origin information and second destination information of a passenger; the server is configured to separately receive origin information and destination information of the package delivery client and a number of passenger clients, and generate a first delivery path according to the first origin information and the first destination information; and when the second origin information is within a first preset distance from the first delivery path and the second destination information is within a second preset distance from the first delivery path, the passengers are listed as possible pickup passengers and prompts are issued.

The present invention further discloses a carpool-based package delivery server, wherein the server is configured to separately receive origin information and destination information of a package delivery client and a number of passenger clients, and generate first delivery path according to the first origin information and the first destination information; and when the second origin information is within a first preset distance from the first delivery path and the second destination information is within a second preset distance from the first delivery path, list the passengers as possible pickup passengers and issue prompts.

Compared with the prior art, the present invention is easy to operate. By using the origin information and the destination information of the package, a possible carpool passenger nearby may be screened out from the beginning, not only ensuring that the package can arrive at the destination on time with a reduced price, but also ensuring that the riding customer can ride at a discount through such carpool.

### BRIEF DESCRIPTION OF THE DRAWINGS

FIG. 1 is a flowchart of a carpool-based package delivery method according to the present invention; and

FIG. 2 is a schematic structural diagram of an embodiment of a carpool-based package delivery system according to the present invention.

### DETAILED DESCRIPTION OF THE INVENTION

The solutions of the present invention will be described in detail below in combination with preferred embodiments.

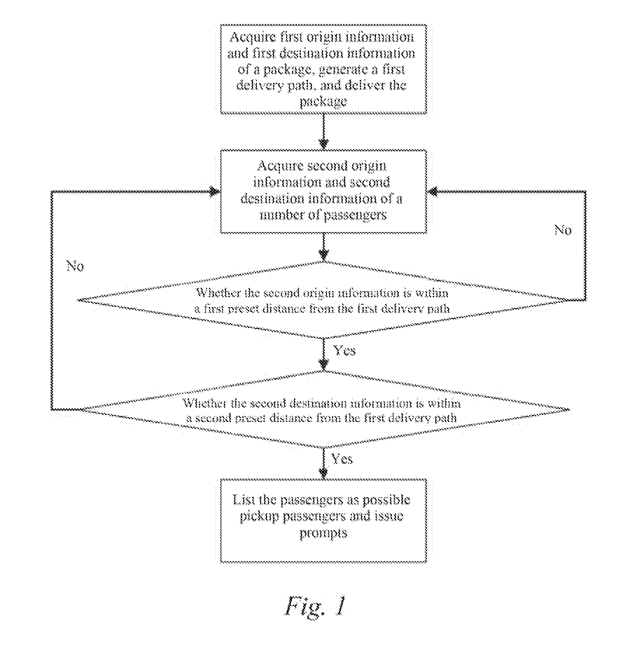

As shown in FIG. 1, a method in this embodiment includes the following steps:

S101: Acquire first origin information and first destination information of a package, generate a first delivery path, and deliver the package.

It usually takes 6 hours or even 12 hours to complete the delivery of packages within a same city or from adjacent cities. Average package companies cannot handle the delivery of some urgent packages (for example, those that need to be delivered in two to three hours). The goods can be brought to a designated person only by taking a taxi to a destination by a person, and then taking a taxi back to an origin, which wastes manpower and additionally produces taxi costs.

The package can be delivered from the origin to the destination by acquiring the first origin information and the first destination information of the package and generating the first delivery path, and calling a taxi nearby. But in this way, relatively high costs need to be paid for each taxi call.

The package is brought into a taxi at a location 0 (the first origin information is known by default), and a taxi driver is informed of the first destination information. At this time, the origin and destination information of the passenger can be uploaded to the server via a passenger client (mobile phone) or a mobile phone of the taxi driver or another communication terminal. The server acquires content of a database and generates the first delivery path based on empirical values. As a more preferred example, the server may also generate the delivery path according to traffic congestion conditions at that time. In general, various factors are taken into account when a taxi is taken. The time factor and the price factor are the main considerations. In this embodiment, the time factor is mainly considered. In a method for generating the delivery path, the origin and the destination of the delivery are determined, and the first M shortest travel paths from the origin to the destination are selected; each of the M travel paths is divided into a number of short paths, an average speed of the taxi when traveling on each short path is calculated, then an average time of the taxi when traveling on each short path is calculated according to the length of each short path, and the average times on the short paths are added to obtain a total travel time on each travel path; and the travel times on the travel paths are compared, and a path with the shortest travel time is used as a fastest travel path (that is, selected as the first delivery path).

In addition, if there are many packages nearby, the packages can be sent together.

S102: Acquire second origin information and second destination information of a number of passengers.

Information about a number of taxis nearby that have carried passengers is continuously collected within a latest arrival time allowed for the package, and the second origin information and the second destination information of the number of passengers are considered. After acquiring the first origin information and the first destination information of the package, the user terminal continuously receives the second origin information and the second destination information of N passengers nearby. Because after starting a ride, the taxi will generate different combinations of package and person according to actual situations, and for the package and the following passenger, among the different combinations of package and person, costs are less when a path distance that the driver detours to pick up the passenger is shorter, which in turn increases the utilization of taxi resources. Therefore, it is of great importance to choose the best carpool combination among a number of combinations of package and person. In addition, the delivery path and the riding path are preset paths stored in the database, and for empirical data that can be retrieved from the database after the passenger enters the origin and destination information, the impact of environmental factors at that time is generally not take into account. If the environmental factors are taken into account, a fastest travel path may be used.

To ensure the effectiveness of the combination of package and person, whether directions of the package and the passenger are the same needs to be known in advance. Therefore, it is necessary to acquire delivery path direction information by using the first origin information and the first destination information first, and then acquire riding path direction information according to the second origin information and the second destination information of the passenger, and ensure that the delivery path direction information is the same as the riding path direction information.

S103: When the second origin information is within a first preset distance from the first delivery path and the second destination information is within a second preset distance from the first delivery path, list the passengers as possible pickup passengers and issue prompts.

In the real life, carpooling of package and person is complex, but with the prevalence of carpooling software, carpooling of package and person is possible. Within a latest arrival time allowed for the package, for example, the package is sent at 8 a.m. from the origin, and is required to arrive at the destination within 2 hours, while the taxi only needs to travel 30 minutes from the origin to the destination. Then during this period of time, the taxi can take passengers nearby, as long as the package can be delivered on time. Therefore, by using the origin information and the destination information of the package, a possible carpool passenger nearby screened out from the beginning, not only ensuring that the package can arrive at the destination on time with a reduced price, but also ensuring that the riding customer can ride at a discount through such carpool.

The combination of package and person needs to satisfy the effect that the package is delivered on time and the person can be promptly sent to the destination. Therefore, package arrival time information is acquired; a time taken by the taxi to travel from a second origin where the passenger is picked up to a first destination is calculated, so as to acquire taxi arrival time information; and when the taxi arrival time information is later than the delivery arrival time information, the passenger is excluded from the possible pickup passengers. An arrival time of each package is determined by a sender from the beginning. After receiving a call request from another passenger, the taxi also needs to ensure that the package can reach the recipient on time. A time taken to arrive at the package destination needs to be calculated from the riding origin of the carpooling passenger, and finally passengers are screened according to the comparison between the taxi arrival time information and the package arrival time information. As there may be unexpected situations, a certain buffer needs to be provided for this time, and the package delivery user and the passenger may be prompted as needed.

Because between two places that seem quite close on a satellite map, the taxi may detour a long distance during actual driving. Therefore, the carpooling prompt should be canceled according to actual situations, and specific implementation steps are: generating a second travel path according to the first origin information and the second destination information of the package and the second origin information and the second destination information of the passenger; and excluding the corresponding taxi from possible delivery taxis if a difference between the second travel path and the travel path is greater than a preset path length. The default path length herein is an empirical value, which can be set by the first passenger or the driver according to actual situations.

In addition, there may be a second passenger on the way, then there may also be carpooling in this case. Specific steps are: acquiring origin information and destination information of the second passenger; and if a distance between the origin information of the second passenger is within the first preset distance from the travel path and the destination information of the third passenger is within the second preset distance from the travel path, issuing a carpool prompt to the second passenger.

The current package delivery and receipt problems are also problems annoying many users. Outstanding problems are mainly as follows: 1. a package is delivered in the working hours (9:00 a.m. to 18:00 p.m.), and in many cases users need to work and are not at home; and 2, there are some communities where security control is relatively complex, users usually need to go downstairs to receive packages. In view of the above problems, for delivery of packages of users within a same community, the present invention proposes providing, by a resident in the community, a delivery service to another resident in the community by registration. This can reduce the impact of the access control on the courier, and the advantage of being in the same community can also be taken, so that a package can be promptly received at anytime. Specific implementation is as follows: address information of a first user in a community is acquired after the package is delivered to the first destination; address information of a number of second users corresponding to all current packages is acquired; and packages for which address information of the second user is within a preset distance range from the first user are screened out and delivered by the first user.

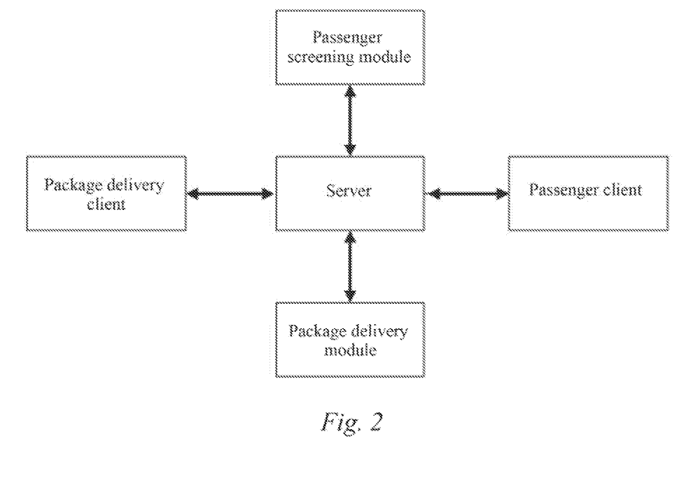

FIG. 2 shows a schematic structural diagram of an embodiment of a carpool-based package delivery system according to the present invention.

A carpool-based package delivery system includes a package delivery client, a server, and a passenger client, with each terminal connected to the server via a network. The package delivery client is configured to acquire first origin information and first destination information of a package; the passenger client is configured to acquire second origin information and second destination information of a passenger; the server is configured to separately receive origin information and destination information of the package delivery client and a number of passenger clients, and generate a first delivery path according to the first origin information and the first destination information; and when the second origin information is within a first preset distance from the first delivery path and the second destination information is within a second preset distance from the first delivery path, the passengers are listed as possible pickup passengers and prompts are issued.

The system further includes a passenger screening module configured to acquire package arrival time information; calculate a time taken by a taxi to travel from a second origin where the passenger is picked up to a first destination, so as to acquire taxi arrival time information; and if the taxi arrival time information is later than the delivery arrival time information, exclude the passenger from the possible pickup passengers.

In addition, the system further includes an package delivery module configured to acquire address information of a first user in a community after the package is delivered to the first destination; acquire address information of a number of second users corresponding to all current packages; and screen out packages for which address information of the second user is within a preset distance range from the first user, and assign the packages to the first user for delivery.

In the real life, carpooling of package and person is complex, but with the prevalence of carpooling software, carpooling of package and person is possible. Within a latest arrival time allowed for the package, for example, the package is sent at 8 a.m. from the origin, and is required to arrive at the destination within 2 hours, while the taxi only needs to travel 30 minutes from the origin to the destination. Then during this period of time, the taxi can take passengers nearby, as long as the package can be delivered on time. Therefore, by using the origin information and the destination information of the package, a possible carpool passenger nearby screened out from the beginning, not only ensuring that the package can arrive at the destination on time with a reduced price, but also ensuring that the riding customer can ride at a discount through such carpool.

The combination of package and person needs to satisfy the effect that the package is delivered on time and the person can be promptly sent to the destination. Therefore, package arrival time information is acquired; a time taken by the taxi to travel from a second origin where the passenger is picked up to a first destination is calculated, so as to acquire taxi arrival time information; and when the taxi arrival time information is later than the delivery arrival time information, the passenger is excluded from the possible pickup passengers. An arrival time of each package is determined by a sender from the beginning. After receiving a call request from another passenger, the taxi also needs to ensure that the package can reach the recipient on time. A time taken to arrive at the package destination needs to be calculated from the riding origin of the carpooling passenger, and finally passengers are screened according to the comparison between the taxi arrival time information and the package arrival time information. As there may be unexpected situations, a certain buffer needs to be provided for this time, and the package delivery user and the passenger may be prompted as needed.

The system embodiment and the method embodiment of the present invention match with each other, and the technical effects and benefits that can be achieved are consistent with the method embodiment of the present invention and are not repeated herein.

As a preferred embodiment, the present invention further provides a carpool-based package delivery server. The server is configured to separately receive origin information and destination information of a package delivery client and a number of passenger clients, and generate first delivery path according to the first origin information and the first destination information; and when the second origin information is within a first preset distance from the first delivery path and the second destination information is within a second preset distance from the first delivery path, list the passengers as possible pickup passengers and issue prompts.

Herein, the setting of the travel path, the origin information, and the destination information, and the preset distances are the same as those of the system section of the present invention, and an implementation manner thereof is also the same as that of the method embodiment of the present invention, and will not be repeated herein.

The embodiments described above merely explain implementations of the present invention, which are described with specifics and details, but should not be thereby understood as limiting the scope of the present invention. It should be noted that a person of ordinary skill in the art may also make a number of variations and improvements without departing from the concept of the present invention, all of which shall fall within the protection scope of the present invention. Therefore, the protection scope of the present invention shall subject to the appended claims.

I claim:

1. A carpool-based package delivery method, comprising:
acquiring first origin information and first destination information of a package;
generating a first delivery path to deliver the package;
acquiring second origin information and second destination information of a plurality of passengers; and
listing the plurality of passengers as possible pickup passengers and issuing a plurality of prompts, when the second origin information is within a first preset distance from the first delivery path and the second destination information is within a second preset distance from the first delivery path.

2. The package delivery method according to claim 1 further comprises acquiring package arrival time information;
calculating a time taken by a taxi to travel from a second origin where a first passenger is picked up to a first destination to acquire taxi arrival time information; and
excluding the first passenger from the possible pickup passengers if the taxi arrival time information is later than delivery arrival time information.

3. The package delivery method according to claim 1, wherein delivery path direction information is acquired according to the first origin information and the first destination information;
riding path direction information is acquired according to the second origin information and the second destination information of the plurality of passengers; and
the delivery path direction information is the same as the riding path direction information.

4. The package delivery method according to claim 1 further comprises:
acquiring address information of a first user in a community after the package is delivered to a first destination;
acquiring address information of a plurality of second users corresponding to a plurality of current packages; and
screening out and delivering the plurality of current packages of the plurality of second users by the first user, when address information of each of the plurality of second users is within a preset distance range from the first user.

5. The package delivery method according to claim 2 further comprises:
acquiring address information of a first user in a community after the package is delivered to the first destination;
acquiring address information of a plurality of second users corresponding to a plurality of current packages; and
screening out and delivering the plurality of current packages of the plurality of second users by the first user, when address information of each of the plurality of second users is within a preset distance range from the first user.

6. The package delivery method according to claim 3 further comprises:
acquiring address information of a first user in a community after the package is delivered to the first destination;
acquiring address information of a plurality of second users corresponding to a plurality of current packages; and
screening out and delivering the plurality of current packages of the plurality of second users by the first user, when address information of each of the plurality of second users is within a preset distance range from the first user.

7. A carpool-based package delivery system, comprising:
a package delivery client;
a server; and
a passenger client; wherein
first origin information and first destination information of a first package of the package delivery client is acquired;
second origin information and second destination information of a passenger is acquired;
the server separately receives the first origin information and the first destination information of the package delivery client and the second origin information and the second destination information of the passenger client, and generates a first delivery path according to the first origin information and the first destination information; and
when the second origin information is within a first preset distance from the first delivery path and the second destination information is within a second preset distance from the first delivery path, the passenger client are listed as possible pickup passengers and a plurality of prompts are issued.

8. The package delivery system according to claim 7, further comprising a passenger screening module configured to acquire package arrival time information and calculate a time taken by a taxi to travel from a second origin where a first passenger is picked up to a first destination to acquire taxi arrival time information; and if the taxi arrival time information is later than the delivery arrival time information, exclude the first passenger from the possible pickup passengers.

9. The package delivery system according to claim 7, further comprising a package delivery module configured to acquire address information of a first user in a community after the package is delivered to a first destination and acquire address information of a plurality of second users corresponding to a plurality of current packages, and screen out packages of the plurality of second users whose address information is within a preset distance range from the first user, and assign the packages to the first user for delivery.

10. The package delivery system according to claim 8, further comprising a package delivery module configured to acquire address information of a first user in a community after the package is delivered to a first destination and acquire address information of a plurality of second users corresponding to a plurality of current packages, and screen out packages of the plurality of second users whose address information is within a preset distance range from the first user, and assign the packages to the first user for delivery.

11. A carpool-based package delivery server, wherein the server is configured to separately receive first origin information and first destination information of a package delivery client and second origin information and second destination information of a plurality of passenger clients, and generate first delivery path according to the first origin information and the first destination information;
when the second origin information is within a first preset distance from the first delivery path and the second destination information is within a second preset distance from the first delivery path, list the plurality of passengers as possible pickup passengers and issue prompts.

12. The package delivery server according to claim 11, wherein the server is configured to acquire package arrival time information and calculate a time taken by a taxi to travel from a second origin where a passenger is picked up to a first destination to acquire taxi arrival time information; if the taxi arrival time information is later than the delivery arrival time information, the passenger is excluded from the possible pickup passengers.

13. The package delivery server according to claim 11, wherein the server is configured to acquire address information of a first user in a community after the package is delivered to the first destination and acquire address information of a plurality of second users corresponding to a plurality of current packages, and screen out packages of the plurality of second users whose address information is within a preset distance range from the first user, and assign the packages to the first user for delivery.

14. The package delivery server according to claim 12, wherein the server is configured to acquire address information of a first user in a community after the package is delivered to the first destination and acquire address information of a plurality of second users corresponding to a plurality of current packages, and screen out packages for the plurality of second users whose address information is within a preset distance range from the first user, and assign the packages to the first user for delivery.
